(19) United States
(12) Patent Application Publication
(10) Pub. No.: US 2026/0067704 A1
(43) Pub. Date: Mar. 5, 2026

(54) Radio Wave Analysis Apparatus and Radio Wave Analysis Method

(71) Applicant: Hitachi, Ltd., Tokyo (JP)

(72) Inventors: Tsukasa FUNANE, Tokyo (JP); Yosuke TANABE, Tokyo (JP); Hisatoshi KIMURA, Tokyo (JP); Makoto ITO, Tokyo (JP); Koichi WATANABE, Tokyo (JP); Shinichi SAITO, Tokyo (JP)

(21) Appl. No.: 19/280,233

(22) Filed: Jul. 25, 2025

(30) Foreign Application Priority Data
Aug. 28, 2024 (JP) 2024-146289

(51) Int. Cl. H04W 16/18

(52) U.S. Cl. CPC H04W 16/18

(57) ABSTRACT

A radio wave analysis apparatus analyzes a radio wave having a geometric structure, and includes: a radio signal acquisition section that acquires, as a reception radio signal, a complex signal of a reception electric field of each of elements of an array antenna; an orthogonal basis expansion section that calculates orthogonal basis components including an orbital angular momentum component from the reception radio signal; a reference structure acquisition section that acquires reference structure information for identifying components of the radio wave corresponding to first and second orthogonal bases, respectively, used in modulation of the radio wave through a geometric structure; and a reconstruction computation section that uses the orthogonal basis components and the reference structure information to compute, as a reconstructed geometric structure, an elevation angle, an azimuth angle, and a radius on a spherical surface having the first and second orthogonal bases as poles.

### CROSS-REFERENCE TO RELATED APPLICATION

This application claims priority to Japanese Patent Application No. 2024-146289 filed on Aug. 28, 2024, the entire contents of which are incorporated by reference herein.

### BACKGROUND OF THE INVENTION

### 1. Field of the Invention

The present invention relates to a radio wave analysis apparatus and a radio wave analysis method for communication, radar imaging, or object detection/recognition.

### 2. Description of the Prior Art

Methods of analyzing radio waves for communication, radar imaging, and object detection/recognition have been proposed. U.S. Pat. No. 11,791,556-B describes a method in which two types of electromagnetic waves having an orbital angular momentum wavefront and a non-orbital angular momentum wavefront, respectively, are transmitted toward a target, two different signals are generated by capturing returned waves, and differences between transmission and reception signals are used to calculate information about the target. Meanwhile, in U.S. Pat. No. 9,258,051-B, one Poincaré sphere is constructed to perform polarization observation and analysis. U.S. Pat. No. 9,258,051-B describes a method of optimizing the polarization state of a downlink signal by representing a change in the polarization state of an uplink signal during propagation as a change in a position on the Poincaré sphere.

U.S. Pat. No. 11,791,556-B describes a method in which information about polarization parameters and each order of orbital angular momentum is used to acquire the azimuth angle, range, speed information, etc., of the target, but does not describe an information representation on a Poincaré sphere using an arbitrary orthogonal basis, and thus, the method described therein is limited in information representation capability. Meanwhile, in U.S. Pat. No. 9,258,051-B, the orthogonal basis is limited to two polarization bases alone, and therefore, representational capability is limited in the case where state representation is aimed at.

### SUMMARY OF THE INVENTION

A radio wave analysis apparatus according to an embodiment of the present invention is a radio wave analysis apparatus that analyzes a radio wave having a geometric structure, the radio wave analysis apparatus including: a radio signal acquisition section that acquires, as a reception radio signal, a complex signal of a reception electric field of each of elements of an array antenna that receives the radio wave; an orthogonal basis expansion section that calculates two or more orthogonal basis components from the reception radio signal; a reference structure acquisition section that acquires reference structure information for identifying components of the radio wave corresponding to a first orthogonal basis and a second orthogonal basis, respectively, the first and second orthogonal bases being orthogonal to each other and being used in modulation of the radio wave through a geometric structure; and a reconstruction computation section that uses the orthogonal basis components and the reference structure information to compute, as a reconstructed geometric structure, an elevation angle, an azimuth angle, and a radius on a spherical surface having the first orthogonal basis and the second orthogonal basis as poles with respect to the geometric structure of the radio wave. The orthogonal basis components include an orbital angular momentum component.

According to the present invention, an increase in information representation capability of radio waves, hence an improvement in communication capacity or object detection resolution, can be achieved through use of information representation based on orthogonal bases with a high degree of freedom allowing numerous combinations. Other problems and novel features will become apparent from the description of the present specification and the accompanying drawings.

### BRIEF DESCRIPTION OF THE DRAWINGS

FIG. 1A is a block diagram of a radio wave analysis apparatus according to a first embodiment;

FIG. 1B is a diagram representing a geometric structure of a radio wave;

FIG. 2A is a flowchart of processing performed in the radio wave analysis apparatus according to the first embodiment;

FIG. 2B illustrates an example hardware configuration of a computer;

FIG. 3 is a block diagram of a radio wave analysis apparatus according to a second embodiment;

FIG. 4 is a flowchart of processing performed in the radio wave analysis apparatus according to the second embodiment;

FIG. 5 illustrates an example configuration of a radio signal acquisition section;

FIG. 6 illustrates an example representation of a reconstructed geometric structure on a spherical surface;

FIG. 7 illustrates an example representation of a change in the reconstructed geometric structure over time on the spherical surface;

FIG. 8A illustrates example changes over time in a geometric structure of a transmission radio signal and a geometric structure of a reception radio signal;

FIG. 8B illustrates example changes over time in the geometric structure of the transmission radio signal and the geometric structure of the reception radio signal;

FIG. 8C illustrates example changes over time in the geometric structure of the transmission radio signal and the geometric structure of the reception radio signal; and

FIG. 9 is a block diagram of a radio wave analysis apparatus according to a third embodiment.

### DESCRIPTION OF THE PREFERRED EMBODIMENT

Radio wave analysis apparatuses according to embodiments of the present invention are apparatuses that acquire and analyze radio waves in which two or more basis components (i.e., orthogonal basis components) orthogonal to each other are superimposed (such radio waves are referred to as radio waves having a geometric structure). Here, the term “orthogonal basis” refers to a basis in which the inner product of basis vectors is zero. In the case where a received radio wave has polarization components as orthogonal basis components, the radio wave having a geometric structure is a polarization-superimposed signal in which mutually orthogonal polarizations are superimposed. In the case where a received radio wave has orbital angular momentum (OAM) components as orthogonal basis components, the radio wave having a geometric structure is a multi-order OAM-superimposed signal in which OAM components with mutually orthogonal orders (or OAM modes) and rotation directions are superimposed.

### First Embodiment

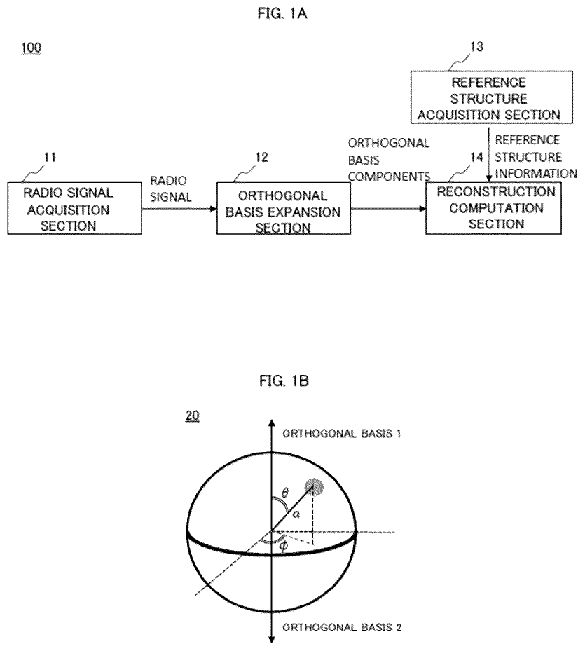

FIG. 1A is a block diagram of a radio wave analysis apparatus 100 according to a first embodiment. The radio wave analysis apparatus 100 has an example configuration suitable for communication applications. A transmission unit (not depicted) transmits a radio wave having a geometric structure. As illustrated in FIG. 1B, in the transmission unit, a signal is transmitted after being encoded to three spherical surface parameters indicating a geometric structure (an elevation angle θ, an azimuth angle φ, and a radius a) on a spherical surface 20 defined by two orthogonal bases 1 and 2. A reception unit provided with the radio wave analysis apparatus 100 receives the radio wave having the geometric structure transmitted from the transmission unit, analyzes the received radio wave, and reconstructs the geometric structure thereof, thereby decoding the transmitted signal.

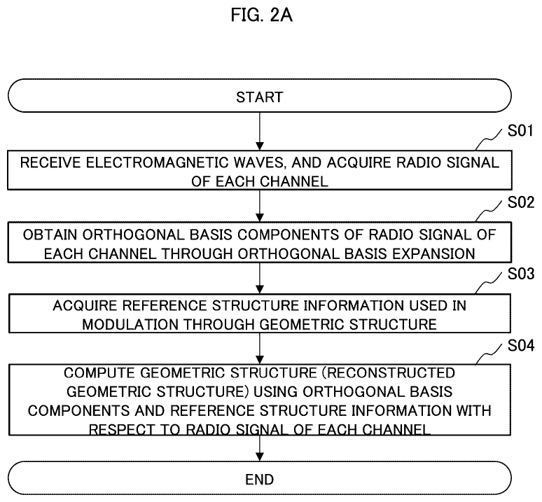

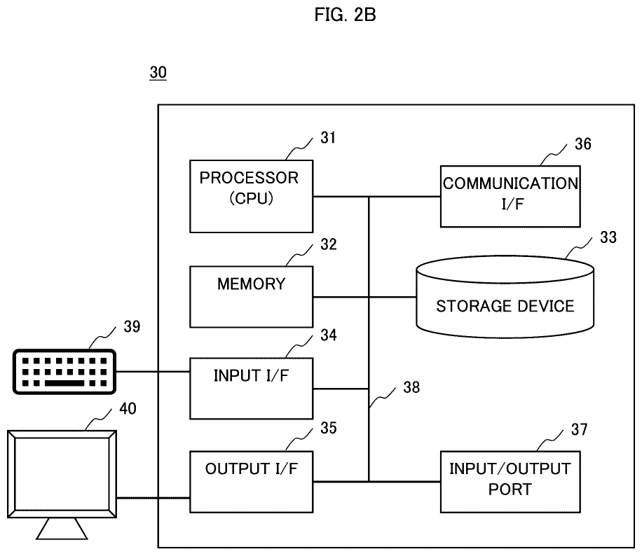

The radio wave analysis apparatus 100 includes a radio signal acquisition section 11, an orthogonal basis expansion section 12, a reference structure acquisition section 13, and a reconstruction computation section 14. With reference to FIG. 2A, an outline of processing performed by each of the blocks will be described below. Note that radio signals transmitted and received between the transmission unit and the reception unit are multiplexed radio signals of a plurality of channels, each having a geometric structure.

The radio signal acquisition section 11 receives electromagnetic waves, and acquires the radio signal of each channel (S01). The orthogonal basis expansion section 12 obtains orthogonal basis components of the radio signal of each channel through orthogonal basis expansion (S02). The orthogonal basis components of the radio signal are polarization components and/or OAM components. When the acquired radio signal has polarization components, the orthogonal basis components are a combination of horizontal and vertical polarization components, or a combination of right-handed and left-handed circular polarization components. When the acquired radio signal has OAM components, the orthogonal basis components are a combination of clockwise or counterclockwise OAM components of arbitrary orders (OAM modes).

The reference structure acquisition section 13 acquires reference structure information regarding the received electromagnetic waves in advance (S03). Here, the reference structure information refers to information for identifying a combination of components of the electromagnetic waves corresponding to the orthogonal bases 1 and 2 used in modulation of the electromagnetic waves through a geometric structure. A plurality of combinations of orthogonal basis components are sometimes used simultaneously for modulation. A method by which the reference structure acquisition section 13 acquires the reference structure information depends on a system to which the present embodiment is applied. For example, the reference structure acquisition section 13 may acquire the reference structure information by receiving, from the transmission unit or a higher-level system, control data for identifying the orthogonal bases 1 and 2 used in the modulation. It is sufficient if the reference structure information is acquired prior to a reconstruction computation process (S04), and the reference structure information may be acquired at a timing irrelevant to steps S01 and S02 in FIG. 2A.

With respect to the radio signal of each channel, the reconstruction computation section 14 selects, from among the orthogonal basis components obtained by the orthogonal basis expansion section 12, orthogonal basis components corresponding to the orthogonal bases identified by the reference structure information, and computes a geometric structure (spherical surface parameters) including an elevation angle θ, an azimuth angle φ, and a radius a on a spherical surface constructed based on the selected bases. The geometric structure obtained by the reconstruction computation section 14 is referred to as a reconstructed geometric structure.

For example, if the spherical surface parameters of the elevation angle θ, the azimuth angle φ, and the radius a can each be transmitted and received with ten divisions, it becomes possible to transmit and receive 10³ (=1000) patterns of information using one pair of orthogonal bases. Analysis of radio waves using spherical surfaces as described above allows information representation with a plurality of combinations of orthogonal bases, achieving a high degree of freedom, and, in the case of communication, makes it easier to achieve an increased number of levels (i.e., increase the number of modulation levels), leading to increased communication capacity. Further, an increase in the communication capacity can be achieved by increasing the number of orders (OAM modes), and thereby increasing the number of spatial multiplexing channels. Note that, regarding a method of dividing the spherical surface, not only the aforementioned method but also other methods may be adopted. For example, vertex positions of a polyhedron created by repeatedly subdividing each of faces of a regular dodecahedron or a regular icosahedron, which is a regular polyhedron that approximates a sphere, into equilateral triangles may be transmitted and received as information. This leads to any position on the spherical surface being equally distant from every adjacent point, which equalizes observation accuracy required in identifying information (position on the spherical surface) in reception.

### Second Embodiment

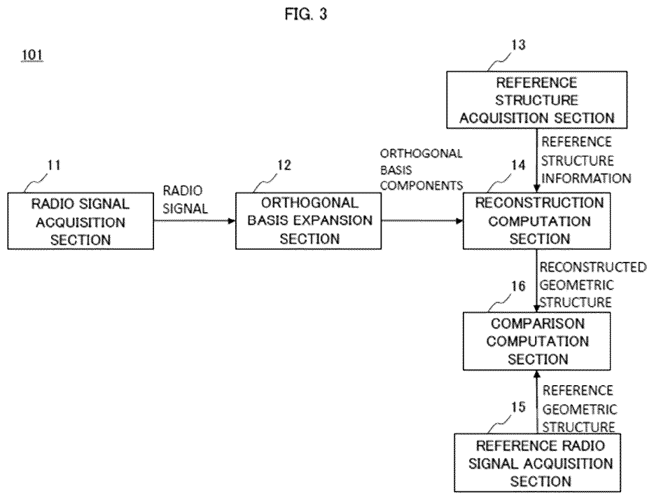

FIG. 3 is a block diagram of a radio wave analysis apparatus 101 according to a second embodiment. The radio wave analysis apparatus 101 has an example configuration suitable for radar imaging and object detection/recognition applications. A transmission unit (not depicted) transmits a radio wave having a geometric structure. A transmission radio signal has a geometric structure (an elevation angle θ, an azimuth angle φ, and a radius a) on a spherical surface 20 defined by two orthogonal bases 1 and 2 as illustrated in FIG. 1B. A reception unit provided with the radio wave analysis apparatus 101 receives, for example, a radio wave of the transmission radio signal transmitted by the transmission unit and returned from some object after undergoing reflection or scattering. The reflector or scatterer that has caused the reflection or scattering of the transmission radio signal can be analyzed by analyzing the received radio wave, reconstructing the geometric structure thereof, and comparing the reconstructed geometric structure with the geometric structure of the transmission radio signal.

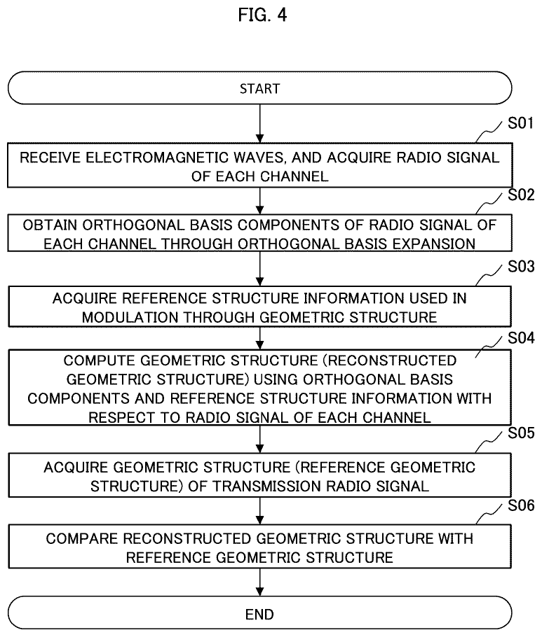

The radio wave analysis apparatus 101 includes a reference radio signal acquisition section 15 and a comparison computation section 16 in addition to the radio signal acquisition section 11, the orthogonal basis expansion section 12, the reference structure acquisition section 13, and the reconstruction computation section 14 provided in the first embodiment. With reference to FIG. 4, an outline of processing performed by each of the blocks will be described below.

Processes performed by the radio signal acquisition section 11, the orthogonal basis expansion section 12, the reference structure acquisition section 13, and the reconstruction computation section 14 are similar to those in the first embodiment, and redundant description is omitted. The reference radio signal acquisition section 15 acquires three spherical surface parameters indicating the geometric structure (the elevation angle θ, the azimuth angle φ, and the radius a) of the transmission radio signal transmitted by the transmission unit (S05). The geometric structure of the transmission radio signal is referred to as a reference geometric structure. It is sufficient if the reference geometric structure is acquired prior to a comparison computation process (S06), and the reference geometric structure may be acquired at a timing irrelevant to steps S01 to S04 in FIG. 4.

The comparison computation section 16 compares the reference geometric structure acquired by the reference radio signal acquisition section 15 with the reconstructed geometric structure computed by the reconstruction computation section 14. For example, differences in each of the spherical surface parameters (the elevation angle θ, the azimuth angle φ, and the radius a) constructed based on the reference structure are calculated. These differences are related to a process of propagation of the radio wave in a target of analysis. Therefore, when a reception radio signal is a received electromagnetic wave reflected from a reflector or a received electromagnetic wave scattered from a scatterer, information indicating features, such as the type and surface characteristics, of the reflector or the scatterer can be acquired.

When the basis components are OAM components, for example, the number of types of reference structures is equal to the number of combinations of two orders that are selected as bases, and information regarding the differences in the three spherical surface parameters, i.e., the elevation angle, the azimuth angle, and the radius, can be acquired with respect to each of the combinations. For example, if OAM components of orders 1 to 3 are selectable for geometric structures of radio waves, a change in the geometric structure can be calculated with respect to a spherical surface of two orders selected from a total of six bases, i.e., clockwise and counterclockwise OAM components of orders 1 to 3. Thus, since information representation with numerous degrees of freedom can be used, it becomes possible to enhance information representation capability during analysis.

The configuration of each of the blocks of the radio wave analysis apparatus 100 according to the first embodiment and the radio wave analysis apparatus 101 according to the second embodiment will be described in detail below. Prior to that, the hardware configuration of the radio wave analysis apparatus will first be described. Each of the orthogonal basis expansion section 12, the reference structure acquisition section 13, the reconstruction computation section 14, the reference radio signal acquisition section 15, and the comparison computation section 16 is implemented by a computer. A part of the radio signal acquisition section 11 can be implemented by a computer through application of software-defined radio technology. FIG. 2B illustrates an example hardware configuration of the computer. A computer 30 includes, as primary components, a processor (CPU) 31, a memory 32, a storage device 33, an input interface (I/F) 34, an output I/F 35, a communication I/F 36, an input/output port 37, and a bus 38 as illustrated in FIG. 2B. The processor 31 performs a process in accordance with a program loaded into the memory 32, thereby functioning as a functional section (block) that provides a prescribed function. The storage device 33 stores the program and data used by the functional section. A nonvolatile storage medium, such as a hard disk drive (HDD) or a solid-state drive (SSD), for example, is used as the storage device 33. The input I/F 34 is an interface to which an input device 39, such as a keyboard or a pointing device, is connected, while the output I/F 35 is an interface to which a display device 40 is connected. The communication I/F 36 enables communication with a computer and so on through a network. The input/output port 37 is connected to a high-frequency circuit of the radio signal acquisition section 11, which will be described below, to accept input of a down-converted reception signal (in the case where the software-defined radio technology is applied). These components are connected to one another through the bus 38 so as to be capable of communicating with one another.

Note that each of the radio wave analysis apparatuses 100 and 101 according to the present embodiments does not need to be implemented on a single computer, and may be implemented on a plurality of computers. Also note that a part of the functional sections (blocks) of each of the radio wave analysis apparatuses 100 and 101 may be implemented as an application on a cloud.

### (Radio Signal Acquisition Section 11)

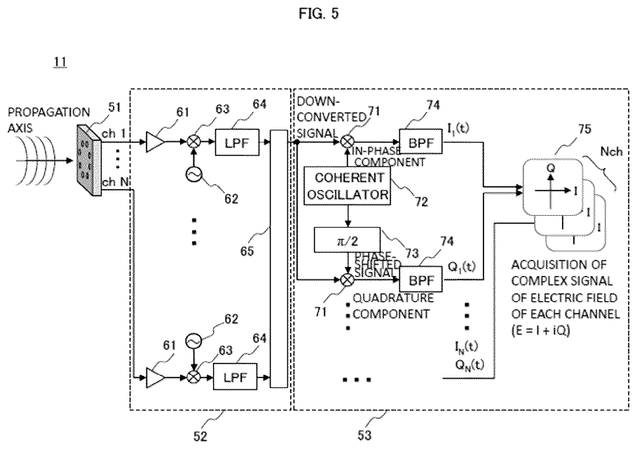

FIG. 5 illustrates an example configuration of the radio signal acquisition section 11. The radio signal acquisition section 11 has a hardware configuration including an antenna 51, a high-frequency circuit 52, and an intermediate-frequency circuit 53. The intermediate-frequency circuit 53 can be substituted by the computer 30 through application of the software-defined radio technology.

The antenna 51 is a circular array antenna provided with N (where N is an integer) elements arranged in a circular configuration. The circular array antenna is an antenna suitable for receiving radio signals having OAM components. A patch antenna, a dipole antenna, a horn antenna, or the like is used as each of the elements of the circular array antenna. Note that, to configure the antenna 51 so as to receive polarization components of an electromagnetic wave, it is necessary to dispose an antenna capable of receiving, for example, a polarization orthogonal basis pair of vertical and horizontal polarizations.

In the high-frequency circuit 52, a radio signal received by the antenna 51 is first amplified by an amplifier 61. Next, the amplified radio signal is mixed with an oscillator signal from a local oscillator 62 in a mixer 63, thereby being down-converted into a frequency band (called an intermediate frequency) corresponding to a difference between the frequency of the received radio wave and the oscillation frequency of the local oscillator 62, and is passed through a low-pass filter 64, and is further subjected to analog-to-digital conversion in an A/D converter 65, resulting in a down-converted signal. This frequency conversion process is called heterodyne detection.

In the intermediate-frequency circuit 53, a coherent oscillator 72 of the same band (i.e., an intermediate frequency band) as that of the down-converted signal is used to extract in-phase and quadrature components with respect to the coherent oscillator 72. The in-phase component is extracted by mixing (multiplying) the down-converted signal with an oscillator signal from the coherent oscillator 72 in a mixer 71 (homodyne detection). Meanwhile, the quadrature component is extracted by generating a phase-shifted signal by subjecting the oscillator signal from the coherent oscillator 72 to phase shifting in a Tr/2 phase shifter 73, and mixing (multiplying) the down-converted signal with the phase-shifted signal in the mixer 71 (homodyne detection). The in-phase component and the quadrature component are passed through a band-pass filter 74 near the intermediate frequency band to be acquired as an I signal and a Q signal, respectively. A complex signal acquisition section 75 calculates a reception electric field, E=I+iQ (where i is the imaginary unit), of each channel, thereby acquiring a complex signal representing the electric field.

Note that the circuit configuration described above is an example, and that a circuit configuration in which any of the amplifier 61, the band-pass filter 74, the low-pass filter 64, and the A/D converter 65 is absent or is disposed at a different position in the sequence is also applicable. For example, it may be arranged such that a process up to the acquisition of the complex signal representing the electric field of each channel is implemented by an analog circuit, and the detected I and Q signals are outputted after being subjected to A/D conversion.

### (Formulation of OAM Radio Wave Transmission)

The orthogonal basis expansion section 12 and the reconstruction computation section 14 analyze, from the received radio wave, the geometric structure used in modulation of the transmission radio signal in the transmission unit. Here, prior to detailed description thereof, modulation of the transmission radio signal transmitted from the transmission unit through the geometric structure will be described below.

It is assumed that the radio wave transmitted by the transmission unit is a radio wave (i.e., a radio vortex) having OAM with multiple orders simultaneously superimposed. It is assumed here that complex signals of orders +I and −I (where I is an integer) are selected as the orthogonal bases of the transmission radio signal, and are selected as a north pole and a south pole, respectively. Note that the sign of the order indicates the rotation direction. At this time, the geometric structure of the transmission radio signal is represented as a point on a spherical surface having the complex signals of the selected orders, i.e., orders ±I, as the orthogonal bases. Note that the orders of OAM components exist infinitely, including orders ±1, ±2, and so on, and have the property of being orthogonal to each other. Accordingly, it is possible to select, as the orthogonal basis components, OAM components of an arbitrary order and an arbitrary rotation direction. For example, a combination of OAM components of orders with the same sign, i.e., plus or minus, such as orders +1 and +2, or a combination of OAM components of positive and negative orders having different numbers, such as orders +1 and −2, can be selected as the orthogonal basis components. Note that the combination of the OAM components selected as the orthogonal basis components of the transmission radio signal corresponds to the reference structure information to be acquired by the reference structure acquisition section 13. It is assumed in the following description that, as a reference structure, OAM components (i.e., complex signals) of orders ±I are selected as the orthogonal bases.

When expressed using a radius (global amplitude) a_{Im}, a phase (global phase) ψ_{Im}, an azimuth angle φ_{Im}, an elevation angle θ_{Im}, and orthogonal basis coefficients L(±I, m) (complex number) at a discrete time m (where m is an integer), the transmission radio signal is represented by a 2×1 complex vector p_{Im} given by Eq. 1 (four variables for each order).

$$\begin{matrix}[ Equation 1 ] & \\ {p}_{lm} = {a}_{lm} {e}^{i {ψ}_{lm}} [ \begin{matrix}{e}^{- i \frac{{ϕ}_{lm}}{2}} cos \frac{{θ}_{lm}}{2} \\ 2 {e}^{i \frac{{ϕ}_{lm}}{2}} sin \frac{{θ}_{lm}}{2}\end{matrix} ] = {e}^{i {ψ}_{lm}} [ \begin{matrix}L ( + l , m ) \\ L ( - l , m )\end{matrix} ] & ( 1 )\end{matrix}$$

It is assumed that three variables, the radius a_{Im}, the azimuth angle φ_{Im}, and the elevation angle θ_{Im}, are used as the geometric structure (i.e., spherical surface parameters) of the radio signal, and the global phase ψ_{Im} is omitted in the following description. Because the three variables are transmitted as information carried on OAM components through the circular array antenna, the signal is transmitted with the phases of the elements of the circular array antenna being displaced from one another. In the case where a radio wave (i.e., an OAM radio wave) having OAM components of order I is transmitted, the amounts of phase shift of the N elements can be expressed as I_{φ0}, I_{φ1}, . . . , I_{φN-1} (φₙ=2πn/N (n=0, 1, . . . , N−1)), respectively, and therefore, in the case where OAM components of orders ±I are simultaneously superimposed, an N×2 complex vector IQ_{I} is given by Eq. 2 as a matrix for transformation into a complex signal.

$$\begin{matrix}[ Equation 2 ] & \\ {IQ}_{l} = [ \begin{matrix}{e}^{il {φ}_{0}} & {e}^{- il {φ}_{0}} \\ {e}^{il {φ}_{1}} & {e}^{- il {φ}_{1}} \\ ⋮ & ⋮ \\ {e}^{il {φ}_{N - 1}} & {e}^{- il {φ}_{N - 1}}\end{matrix} ] & ( 2 )\end{matrix}$$

The product thereof, IQ_{I}p_{Im}, as given by Eq. 3, represents a complex signal representing the three variables of the OAM components of orders ±I which have been subjected to phase rotation to be transmitted from the elements of the circular array antenna with modulation of the OAM components.

$$\begin{matrix}[ Equation 3 ] & \\ {IQ}_{l} {p}_{lm} = {a}_{lm} [ \begin{matrix}{e}^{il {φ}_{0}} & {e}^{- il {φ}_{0}} \\ {e}^{il {φ}_{1}} & {e}^{- il {φ}_{1}} \\ ⋮ & ⋮ \\ {e}^{il {φ}_{N - 1}} & {e}^{- il {φ}_{N - 1}}\end{matrix} ] [ \begin{matrix}{e}^{- i \frac{{ϕ}_{lm}}{2}} cos \frac{{θ}_{lm}}{2} \\ 2 {e}^{i \frac{{ϕ}_{lm}}{2}} sin \frac{{θ}_{lm}}{2}\end{matrix} ] & ( 3 )\end{matrix}$$

The real part of the complex signal corresponds to an I-axis signal of an OAM radio wave of order I (or order −I), and the imaginary part of the complex signal corresponds to a Q-axis signal of the OAM radio wave of order I (or order −I). In a multi-order simultaneous superimposition scheme, the sum totals of each of I-axis signals and Q-axis signals of orders 1 to I at each point in time are up-converted through modulators of N channels. Thus, an electrical signal s(t) of the N channels, given by Eq. 4, to be supplied to the circular array antenna is generated. Here, t is time, and f_{c} is a center frequency [Hz] of up-conversion.

$$\begin{matrix}[ Equation 4 ] & \\ s ( t ) = Real [ {\sum }_{n = 1}^{l} {IQ}_{n} {p}_{nm} ] cos 2 π {f}_{c} t + Imag [ {\sum }_{n = 1}^{l} {IQ}_{n} {p}_{nm} ] sin 2 π {f}_{c} t & ( 4 )\end{matrix}$$

In general, an electric field E that an OAM radio wave of order +I alone produces from a circular array antenna having a radius of b and N elements, at a distance of r, which is sufficiently greater than the radius of b, is represented by Eq. 5a. Here, k is the wave number, J_{I}( ) is the Bessel function of the first kind of order I, and φ and θ are the azimuth angle and elevation angle, respectively, of a reception point when the transmitting circular array antenna is assumed to be at the origin. Similarly, in the case of order −I alone, an electric field E is represented by Eq. 5b.

$$\begin{matrix}[ Equation 5 ] & \\ E ( r , φ , ϑ ) = \frac{{e}^{- ikr}}{r} {Ni}^{l} {e}^{il φ} {J}_{l} ( kb sin ϑ ) & ( 5 a )\end{matrix}$$

$$E ( r , φ , ϑ ) = \frac{{e}^{- ikr}}{r} {Ni}^{- l} {e}^{- il φ} {J}_{- l} ( kb sin ϑ ) \qquad ( 5 b )$$

Here, the orthogonal basis coefficients L(±I, m) are transformed to Eq. 6 through Eq. 1. Note that the orthogonal basis coefficients are values of the orthogonal basis components.

$$\begin{matrix}[ Equation 6 ] & \\ [ \begin{matrix}L ( + l , m ) \\ L ( - l , m )\end{matrix} ] = [ \begin{matrix}{a}_{l m} {e}^{- i \frac{{ϕ}_{l m}}{2}} cos \frac{{θ}_{l m}}{2} \\ {a}_{l m} {e}^{i \frac{{ϕ}_{l m}}{2}} sin \frac{{θ}_{l m}}{2}\end{matrix} ] & ( 6 )\end{matrix}$$

Assuming that complex signals of the orthogonal basis coefficients L(±I, m) at each point m in time are up-converted with a modulation frequency of f_{c} and transmitted, electric fields produced by a radio wave having OAM components of orders ±I, for example, are represented by Eq. 7a and Eq. 7b, respectively, using the right sides of Eq. 5a and Eq. 5b and the right side of Eq. 6.

$$\begin{matrix}[ Equation 7 ] & \\ \begin{matrix}order + \vert : \\ \begin{matrix}E ( r , φ , ϑ , t , m , + l ) = [ \frac{{e}^{- ikr}}{r} {Ni}^{l} {e}^{il φ} {J}_{l} ( kb sin ϑ ) ] \cdot [ {a}_{l m} {e}^{- i \frac{{ϕ}_{l m}}{2}} cos \frac{{θ}_{l m}}{2} ] \cdot {e}^{i 2 π {f}_{c} t} \\ = N \frac{{e}^{- ikr}}{r} {e}^{i 2 π {f}_{c} t} {a}_{l m} {i}^{l} {e}^{- i \frac{{ϕ}_{l m}}{2}} cos \frac{{θ}_{l m}}{2} {e}^{il φ} {J}_{l} ( kb sin ϑ )\end{matrix}\end{matrix} & ( 7 a )\end{matrix}$$

$$\begin{matrix}order - \vert : \\ \begin{matrix}E ( r , φ , ϑ , t , m , - l ) = [ \frac{{e}^{- ikr}}{r} {Ni}^{- l} {e}^{- il φ} {J}_{- l} ( kb sin ϑ ) ] \cdot [ {a}_{l m} {e}^{- i \frac{{ϕ}_{l m}}{2}} sin \frac{{θ}_{l m}}{2} ] \cdot {e}^{i 2 π {f}_{c} t} \\ = N \frac{{e}^{- ikr}}{r} {e}^{i 2 π {f}_{c} t} {a}_{l m} {i}^{l} {e}^{i \frac{{ϕ}_{l m}}{2}} sin \frac{{θ}_{l m}}{2} {e}^{- il φ} {J}_{l} ( kb sin ϑ )\end{matrix}\end{matrix} \qquad ( 7 b )$$

Accordingly, a generated electric field in a multi-order simultaneous superimposition scheme involving orders from ±1 to ±n is represented by Eq. 8.

$$\begin{matrix}[ Equation 8 ] & \\ E ( r , φ , ϑ , t , m ) = N \frac{{e}^{- ikr}}{r} {e}^{i 2 π {f}_{c} t} {\sum }_{n = 1}^{l} {a}_{n m} [ {i}^{n} {e}^{- i \frac{{ϕ}_{n m}}{2}} cos \frac{{θ}_{n m}}{2} {e}^{i n φ} {J}_{n} ( kb sin ϑ ) + {i}^{n} {e}^{i \frac{{ϕ}_{n m}}{2}} sin \frac{{θ}_{n m}}{2} {e}^{- i n φ} {J}_{n} ( kb sin ϑ ) ] & ( 8 )\end{matrix}$$

### (Formulation of OAM Radio Wave Reception)

The radio signal acquisition section 11 receives a generated electric field E(r, φ, θ, m) in the multi-order simultaneous superimposition scheme involving orders from ±1 to ±n through the antenna 51. At a certain distance r_{R} from a propagation axis of the circular array antenna, a receiving circular array antenna (i.e., the antenna 51) similar to the transmitting circular array antenna is disposed opposite thereto to receive signals of the N channels and observe an entire phase surface of a radio vortex. Note that it is assumed that the distance r_{R} is a relatively short distance. Assuming that the azimuth angle and elevation angle of the receiving circular array antenna are φ_{Rn}=2πn/N (n=0, 1, . . . , N−1) and θ_{R}, respectively, a reception electric field down-converted in each element is represented by Eq. 9.

$$\begin{matrix}[ Equation 9 ] & \\ E ( {r}_{R} , {φ}_{Rn} , {ϑ}_{R} , m ) = N \frac{{e}^{- {ikr}_{R}}}{{r}_{R}} {{\sum }^{l}}_{n = 1} {a}_{n m} [ {i}^{n} {e}^{- i \frac{{ϕ}_{n m}}{2}} cos \frac{{θ}_{n m}}{2} {e}^{i n {φ}_{Rn}} {J}_{n} ( kb sin {ϑ}_{R} ) + {i}^{n} {e}^{i \frac{{ϕ}_{n m}}{2}} sin \frac{{θ}_{n m}}{2} {e}^{- i n {φ}_{Rn}} {J}_{n} ( kb sin {ϑ}_{R} ) ] & ( 9 )\end{matrix}$$

Here, a reception electric field involving order +I alone is represented by Eq. 10 through Eq. 7a.

$$\begin{matrix}[ Equation 10 ] & \\ E ( {r}_{R} , {φ}_{Rn} , {ϑ}_{R} , m , + l ) = N \frac{{e}^{- {ikr}_{R}}}{{r}_{R}} {a}_{l m} {i}^{l} {e}^{- i \frac{{ϕ}_{l m}}{2}} cos \frac{{θ}_{l m}}{2} {e}^{i l {φ}_{Rn}} {J}_{l} ( kb sin {ϑ}_{R} ) & ( 10 )\end{matrix}$$

### (Orthogonal Basis Expansion Section 12)

Using reception radio signals received by the N-channel circular array antenna and acquired in the radio signal acquisition section 11 (i.e., a complex signal of the reception electric field of each channel), the orthogonal basis expansion section 12 calculates the orthogonal basis coefficients L(±I, m) through orthogonal basis expansion by a spatial Fourier transform. The spatial Fourier transform utilizes orthogonality of complex sine waves to represent the complex signal of the reception electric field of each channel as a linear combination of orthogonal bases.

Specifically, to determine spatial frequency components in the circumference+φ direction (N divisions) of the circular array antenna, a spatial Fourier transform using a circular harmonic function e^{idφ} (d=0, 1, . . . , N−1), which is an orthogonal basis, is performed. Here, d represents the number of waves included in the circumferential direction, and a spatial frequency component (a component of e^{idφ}) corresponding to a certain value of d corresponds to a basis coefficient (L(+d, m)) of an OAM radio wave of order d (m is discrete time). Here, the basis coefficient is a circular harmonic coefficient. Using this coefficient, circular harmonic expansion can be achieved through multiplication and summation with the circular harmonic function. Note that d takes negative values as well (denoted as −d, enabling a spatial Fourier transform in a −φ direction (N divisions)), and a spatial frequency component (a component of e^{-idφ}) corresponding to a certain value of −d corresponds to a basis coefficient (L(−d, m)) of an OAM radio wave of order −d.

Accordingly, the basis coefficient L(+1, m) is obtained as expressed by Eq. 11a, using definitions of a discrete Fourier transform. Similarly, the basis coefficient L(−I, m) is obtained as expressed by Eq. 11b. Here, N² is multiplied on the right side of each of Eq. 11a and Eq. 11b because the contents of the sigma notation involve e^{iIφRn} and e^{-iIφRn} canceling each other out to become 1, resulting in the same value being added N times.

$$\begin{matrix}[ Equation 11 ] & \\ \begin{matrix}L ( + l , m ) = {{\sum }_{n = 0}}^{N - 1} E ( {r}_{R} , {φ}_{Rn} , {ϑ}_{R} , m ) {e}^{- i l {φ}_{Rn}} = N \cdot N \frac{{e}^{- {ikr}_{R}}}{{r}_{R}} {a}_{l m} {i}^{l} {e}^{- i \frac{{ϕ}_{l m}}{2}} cos \frac{{θ}_{l m}}{2} {J}_{l} ( kb sin {ϑ}_{R} ) \\ = {N}^{2} \frac{{e}^{- {ikr}_{R}}}{{r}_{R}} {a}_{l m} {i}^{l} {e}^{- i \frac{{ϕ}_{l m}}{2}} cos \frac{{θ}_{l m}}{2} {J}_{l} ( kb sin {ϑ}_{R} )\end{matrix} & ( 11 a )\end{matrix}$$

$$L ( - l , m ) = {{\sum }_{n = 0}}^{N - 1} E ( {r}_{R} , {φ}_{Rn} , {ϑ}_{R} , m ) {e}^{i l {φ}_{Rn}} = {N}^{2} \frac{{e}^{- {ikr}_{R}}}{{r}_{R}} {a}_{l m} {i}^{l} {e}^{i \frac{{ϕ}_{l m}}{2}} sin \frac{{θ}_{l m}}{2} {J}_{l} ( kb sin {ϑ}_{R} ) \qquad ( 11 b )$$

Note that, in the case where three-dimensional array antennas (including a tensegrity structure) are used as transmitting and receiving antennas, a spherical harmonic function can be used.

Here, a supplementary explanation about the relationships between an antenna structure and an orthogonal basis expansion method will be provided below. In the embodiment described above by way of example, in the case where the antenna 51 is a circular array antenna, the circular harmonic function is used as an orthogonal basis, and circular harmonic coefficients are calculated. The orthogonal basis expansion is performed in accordance with the antenna configuration. In the case where the antenna 51 is an antenna in which elements are arranged in a one-dimensional array, orthogonal basis expansion based on spatial frequencies is performed using a one-dimensional spatial Fourier transform or a one-dimensional fast Fourier transform (FFT). Alternatively, the orthogonal basis expansion may be performed using a one-dimensional discrete cosine transform (DCT). Meanwhile, in the case where the antenna 51 is an antenna in which elements are arranged in a two-dimensional array, orthogonal basis expansion is performed using a two-dimensional spatial Fourier transform or a two-dimensional FFT. Alternatively, the orthogonal basis expansion may be performed using a two-dimensional DCT.

### (Reconstruction Computation Section 14)

The reconstruction computation section 14 recognizes, from the reference structure information acquired by the reference structure acquisition section 13, that the OAM components of orders +I and −I have been selected as the orthogonal basis components of the transmission radio signal. Accordingly, using the orthogonal basis coefficients L(±I, m) obtained by the orthogonal basis expansion section 12, the reconstruction computation section 14 calculates the radius a_{Im}, azimuth angle φ_{Im}, and elevation angle φ_{Im} (i.e., the reconstructed geometric structure) thereof on a spherical surface of the orders (in this example, ±I) of the OAM components selected as the orthogonal basis components.

First, Eq. 12 is derived from Eq. 1, and through transformation of Eq. 12 into Eq. 13 and Eq. 14, the azimuth angle φ_{Im} and the elevation angle θ_{Im} are determined, respectively.

$$\begin{matrix}[ Equation 12 ] & \\ \frac{L ( - l , m )}{L ( + l , m )} = {e}^{i {ϕ}_{l m}} tan ( \frac{{θ}_{l m}}{2} ) & ( 12 )\end{matrix}$$

$$\begin{matrix}[ Equation 13 ] & \\ {ϕ}_{l m} = arg [ L ( - l , m ) / L ( + l , m ) ] & ( 13 )\end{matrix}$$

$$\begin{matrix}[ Equation 14 ] & \\ {θ}_{l m} = 2 {tan}^{- 1} [ \vert L ( - l , m ) \vert / \vert L ( + l , m ) \vert ] & ( 14 )\end{matrix}$$

In addition, taking absolute values of both sides of Eq. 11a and Eq. 11b leads to Eq. 15a and Eq. 15b, respectively, and therefore, the radius a_{Im} is determined by Eq. 16.

$$\begin{matrix}[ Equation 15 ] & \\ \vert L ( + l , m ) \vert = \vert {N}^{2} \frac{{e}^{- {ikr}_{R}}}{{r}_{R}} {a}_{l m} {i}^{l} {e}^{- i \frac{{ϕ}_{l m}}{2}} cos \frac{{θ}_{l m}}{2} {J}_{l} ( kb sin {ϑ}_{R} ) \vert = \vert cos \frac{{θ}_{l m}}{2} \vert {a}_{l m} {N}^{2} {J}_{l} ( kb sin {ϑ}_{R} ) / {r}_{R} & ( 15 a )\end{matrix}$$

$$\vert L ( - l , m ) \vert = \vert {N}^{2} \frac{{e}^{- {ikr}_{R}}}{{r}_{R}} {a}_{l m} {i}^{l} {e}^{i \frac{{ϕ}_{l m}}{2}} sin \frac{{θ}_{l m}}{2} {J}_{l} ( kb sin {ϑ}_{R} ) \vert = \vert sin \frac{{θ}_{l m}}{2} \vert {a}_{l m} {N}^{2} {J}_{l} ( kb sin {ϑ}_{R} ) / {r}_{R} \qquad ( 15 b )$$

$$\begin{matrix}[ Equation 16 ] & \\ \begin{matrix}{a}_{l m} = {r}_{R} \vert L ( + l , m ) \vert / [ {N}^{2} cos ( {θ}_{l m} / 2 ) {J}_{l} ( kb sin {ϑ}_{R} ) ] \\ = {r}_{R} \vert L ( - l , m ) \vert / [ {N}^{2} sin ( {θ}_{l m} / 2 ) {J}_{l} ( kb sin {ϑ}_{R} ) ]\end{matrix} & ( 16 )\end{matrix}$$

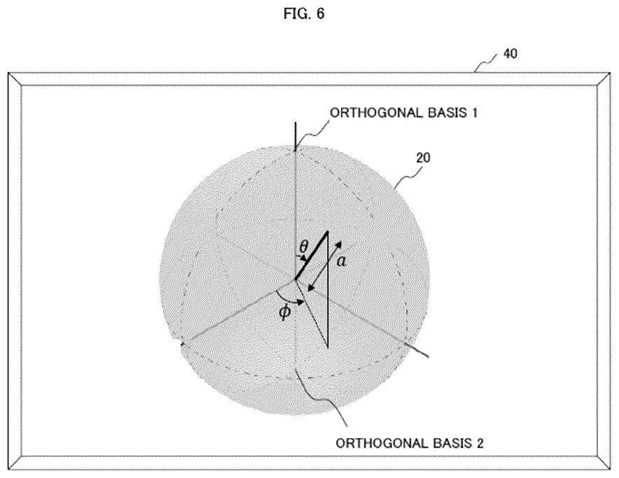

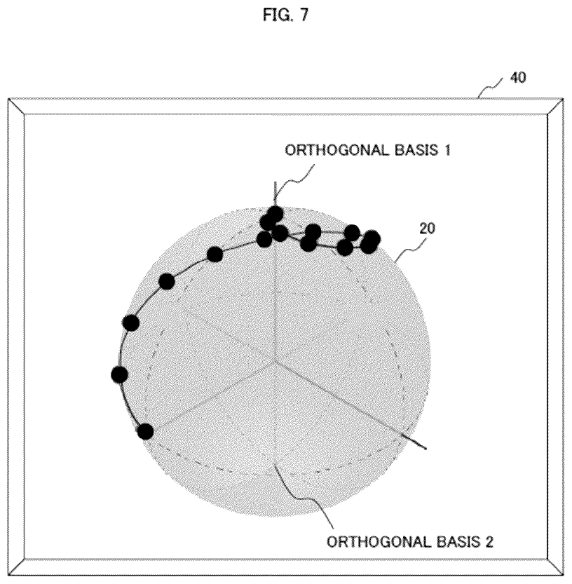

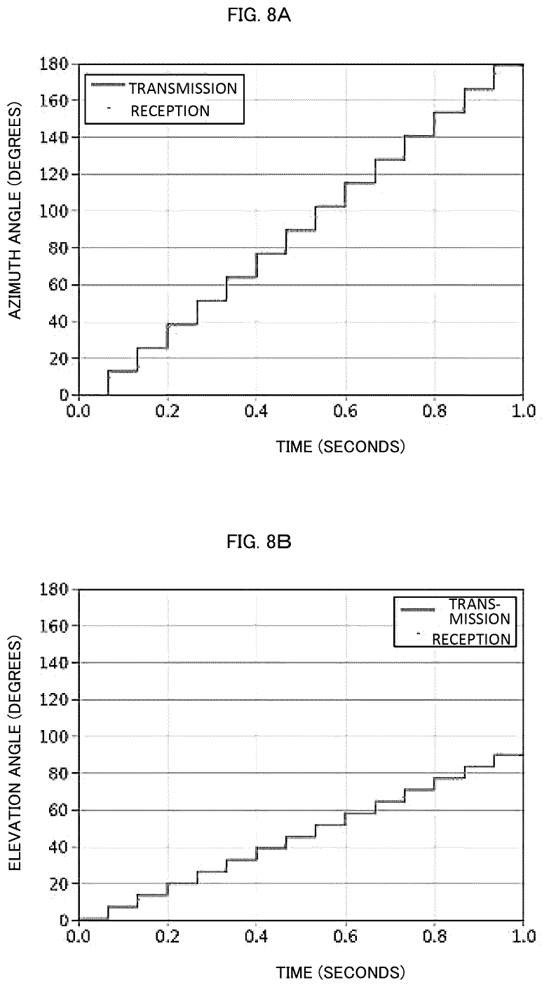

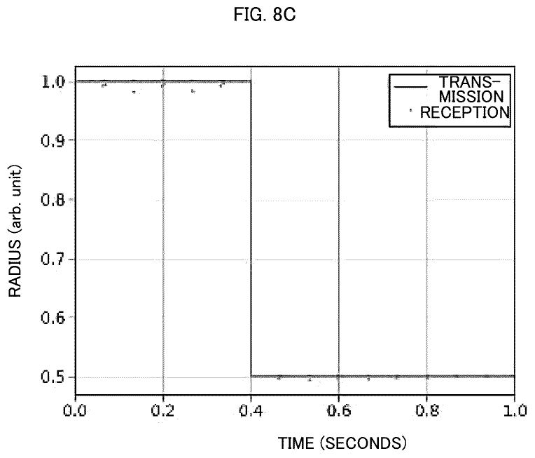

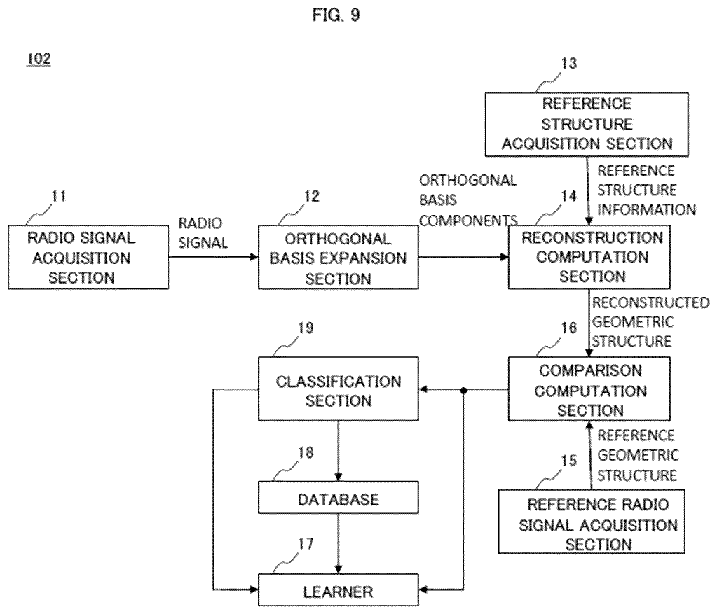

FIG. 6 illustrates an example representation of the reconstructed geometric structure on the spherical surface 20 as displayed on the display device 40. When the orthogonal basis 1 is a counterclockwise OAM component of order I and the orthogonal basis 2 is a clockwise OAM component of order I, an optional state (geometric structure) on a Poincaré spherical surface given by Eq. 1 can be reconstructed. While FIG. 6 represents the geometric structure at a certain point in time (at an arbitrary value of m), it is also possible to represent a change in the geometric structure over time as a movement and locus of a point on the spherical surface. FIG. 7 represents an example output of a change in the reconstructed geometric structure over time. This visualizes the change over time in the geometric structure of the radio wave in a three-dimensional representation, making it easier to grasp a change in characteristics of the radio wave. Further, since the geometric structure of the transmission radio signal (i.e., the reference geometric structure) and the geometric structure of the reception radio signal (i.e., the reconstructed geometric structure) are compared with each other, results of simulating the changes over time in the geometric structure of the transmission radio signal and the geometric structure of the reception radio signal with respect to each of the azimuth angle φ, the elevation angle θ, and the radius a are illustrated in FIGS. 8A, 8B, and 8C. Note that the reception radio signal illustrated in each of FIGS. 8A to 8C is the same as the reception radio signal illustrated in FIG. 7. It is assumed that the units for the azimuth angle φ and the elevation angle θ are degrees, and the unit for the radius a is an arbitrary unit. As illustrated in FIGS. 8A to 8C, the reference geometric structure of the transmission radio signal and the reconstructed geometric structure of the reception radio signal overlap almost completely, indicating that the geometric structure of the transmission radio signal has been successfully reproduced in the reception radio signal.

As an application of the present technique, a change from the reference geometric structure to the reconstructed geometric structure may be represented as a locus or a multi-dimensional vector on the spherical surface 20 (e.g., a three-dimensional vector on the spherical surface 20). Further, representational capability with respect to characteristics of a radio wave which can be detected or characteristics of a target object (a reflector or a scatterer) can be enhanced by creating feature amounts using a plurality of spherical surfaces. For example, a displacement vector x₁₂ on a first spherical surface defined by orthogonal bases 1 and 2 and a displacement vector x₃₄ on a second spherical surface defined by orthogonal bases 3 and 4 can be combined to create a feature amount x₁₂·x₃₄. As a result, in communication applications, the communication capacity can be doubled without changing the number of divisions of each spherical surface parameter, and in radar imaging and object detection/recognition applications, a higher object recognition resolution can be achieved. The components of a radio wave corresponding to a plurality of orthogonal bases which are combined may be any of a combination of polarization components, a combination of OAM components, and a combination of polarization and OAM components. Further, representing a geometric position on a spherical surface as information as described above enables transmission and reception of topology information. Accordingly, even if a disturbance that causes phase rotation or the like to reception information occurs, it can be expected that a geometric pattern to be received will simply experience a distortion or rotation, and the structure thereof will be easily maintained. Thus, the advantageous effect of accomplishing more robust information communication that is highly resistant to disturbances can be achieved.

### (in the Case of Polarized Radio Waves)

While an example case where transmission radio waves are radio vortexes has been described above, similar processing can be performed even in the case where the transmission radio waves are radio waves having polarization components (i.e., polarized radio waves). Hereinafter, processing that is performed by the radio wave analysis apparatus 100 (101) will be described with reference to an example case where, with respect to the reference structure of the transmission radio signal, the orthogonal basis 1 is a horizontal polarization and the orthogonal basis 2 is a vertical polarization. In this case, it is sufficient if the antenna 51 (see FIG. 5) is an array antenna having one element for receiving the horizontal polarization and one element for receiving the vertical polarization.

The transmission radio signal is represented by a 2×1 complex vector p given by Eq. 17 using the azimuth angle φ, the elevation angle θ, and the radius a.

$$\begin{matrix}[ Equation 17 ] & \\ p = a [ \begin{matrix}{e}^{- i \frac{ϕ}{2}} cos \frac{θ}{2} \\ {e}^{i \frac{ϕ}{2}} sin \frac{θ}{2}\end{matrix} ] & ( 17 )\end{matrix}$$

A matrix for transforming the geometric structure represented by Eq. 17 into complex signals is a 2×2 real vector IQ_{HV} given by Eq. 18. The product thereof, IQ_{HV}p, given by Eq. 19, represents two complex signals of the transmission radio signal.

$$\begin{matrix}[ Equation 18 ] & \\ {IQ}_{HV} = [ \begin{matrix}1 & 0 \\ 0 & 1\end{matrix} ] & ( 18 )\end{matrix}$$

$$\begin{matrix}[ Equation 19 ] & \\ {IQ}_{HV} p = a [ \begin{matrix}1 & 0 \\ 0 & 1\end{matrix} ] [ \begin{matrix}{e}^{- i \frac{ϕ}{2}} cos \frac{θ}{2} \\ {e}^{i \frac{ϕ}{2}} sin \frac{θ}{2}\end{matrix} ] & ( 19 )\end{matrix}$$

Here, when it is assumed that, in FIG. 5, channel 1 (ch1) corresponds to an antenna element for receiving a horizontal polarization and channel 2 (ch2) corresponds to an antenna element for receiving a vertical polarization, complex signals of the horizontal polarization and the vertical polarization, denoted by EH and Ev, respectively, are given by Eq. 20. In the case of the polarization components, the complex signals acquired in the radio signal acquisition section 11, as they are, are orthogonal basis components. Accordingly, the reconstruction computation section 14 is able to determine the azimuth angle φ, the elevation angle θ, and the radius a as given by Eq. 21, Eq. 22, and Eq. 23, respectively, using Eq. 19 and Eq. 20.

$$\begin{matrix}[ Equation 20 ] & \\ [ \begin{matrix}{E}_{H} \\ {E}_{V}\end{matrix} ] = [ \begin{matrix}{ae}^{- i \frac{ϕ}{2}} cos \frac{θ}{2} \\ {ae}^{i \frac{ϕ}{2}} sin \frac{θ}{2}\end{matrix} ] & ( 20 )\end{matrix}$$

$$\begin{matrix}[ Equation 21 ] & \\ ϕ = arg [ {E}_{H} / {E}_{V} ] & ( 21 )\end{matrix}$$

$$\begin{matrix}[ Equation 22 ] & \\ θ = 2 {tan}^{- 1} [ \vert {E}_{H} \vert / \vert {E}_{V} \vert ] & ( 22 )\end{matrix}$$

$$\begin{matrix}[ Equation 23 ] & \\ a = \vert {E}_{H} \vert / \vert cos \frac{θ}{2} \vert = \vert {E}_{V} \vert / \vert sin \frac{θ}{2} \vert & ( 23 )\end{matrix}$$

Even in the case where the orthogonal basis 1 is a horizontal polarization and the orthogonal basis 2 is a vertical polarization, the geometric structure of a reception radio wave can be displayed on the display device as illustrated in FIG. 6.

Note that, even in the case where a left-handed circular polarization and a right-handed circular polarization are selected as an orthogonal basis pair selected as polarization bases, similar calculations are possible, and transformation is possible between the orthogonal basis pairs. As described above, it is also possible to acquire both polarization and OAM components as geometric structures, and display the geometric structures simultaneously. In the case where simultaneous analysis is performed, the antenna is arranged to have an antenna structure that enables simultaneous acquisition of the both. When both polarization and OAM components are analyzed, and the states of a polarization and a radio vortex are simultaneously visualized clearly, characteristics of a target can be grasped in greater detail and with higher accuracy.

### (Comparison Computation Section 16)

The comparison computation section 16 may be configured to determine a transformation matrix for transforming the transmission radio signal (i.e., a reference signal) to the reception radio signal in addition to or in place of determining the differences between the reference geometric structure and the reconstructed geometric structure.

The electric field of each element of the circular array antenna when an OAM radio wave of order +I is transmitted and received is represented by Eq. 7a. Accordingly, if the values of the three spherical surface parameters are determined, the electric field due to the OAM radio wave of order +I can be represented as one complex signal having a real part and an imaginary part. Here, it is assumed, for example, that a two-dimensional vector (equivalent to a complex signal having two parameters, the real part and the imaginary part) representing the state of an incident wave that is a radio vortex of order +1 is denoted by xᵢ, and a two-dimensional vector representing the state of a reflected wave is denoted by yₒ. These vectors have relationships therebetween given by Eq. 24 through a transformation matrix of SU(2) (a group consisting of 2×2 unitary matrices with a determinant of 1, also known as a special unitary group of degree 2), which represents a relation of a unitary transformation (a transformation where the value of the inner product of two vectors remains unchanged despite the transformation). Note that a, b, c, and d in the transformation matrix are real numbers.

$$\begin{matrix}[ Equation 24 ] & \\ {y}_{o} = [ \begin{matrix}a & b \\ c & d\end{matrix} ] {x}_{i} & ( 24 )\end{matrix}$$

The comparison computation section 16 calculates the transformation matrix backward using a known complex signal of an incident wave onto an object (i.e., a reference signal (transmission signal)) and a complex signal of a reflected wave from the object (i.e., a reception signal). As illustrated in Eq. 24, the transformation matrix has four elements, and thus corresponds to a rotation matrix for transforming the incident wave to the reflected wave, and essentially expresses characteristics of a reflector or a scatterer or of a propagation path. In other words, the transformation matrix can be treated as a feature amount indicating the characteristics of the target object. Because the number of elements is four, measuring the incident wave and the reflected wave on a minimum of two conditions suffices for the backward calculation of the transformation matrix.

Here, it is assumed that incident wave vectors on observation condition 1 and observation condition 2 are denoted by xᵢ₁=[x₁, x₂]^{T} and xᵢ₂=[x₃, x₄]^{T}, respectively, and reflected wave vectors on observation condition 1 and observation condition 2 are denoted by yₒ₁=[y₁, y₂]^{T} and yₒ₂=[y₃, y₄]^{T}, respectively. In this case, Eq. 25 is derived from Eq. 24.

$$\begin{matrix}[ Equation 25 ] & \\ [ \begin{matrix}{y}_{1} \\ {y}_{2} \\ {y}_{3} \\ {y}_{4}\end{matrix} ] = [ \begin{matrix}{x}_{1} & {x}_{2} & 0 & 0 \\ 0 & 0 & {x}_{1} & {x}_{2} \\ {x}_{3} & {x}_{4} & 0 & 0 \\ 0 & 0 & {x}_{3} & {x}_{4}\end{matrix} ] [ \begin{matrix}a \\ b \\ c \\ d\end{matrix} ] & ( 25 )\end{matrix}$$

$$\begin{matrix}[ Equation 26 ] & \\ [ \begin{matrix}a \\ b \\ c \\ d\end{matrix} ] = {[ \begin{matrix}{x}_{1} & {x}_{2} & 0 & 0 \\ 0 & 0 & {x}_{1} & {x}_{2} \\ {x}_{3} & {x}_{4} & 0 & 0 \\ 0 & 0 & {x}_{3} & {x}_{4}\end{matrix} ]}^{- 1} [ \begin{matrix}{y}_{1} \\ {y}_{2} \\ {y}_{3} \\ {y}_{4}\end{matrix} ] & ( 26 )\end{matrix}$$

The elements a to d of the transformation matrix can be calculated by Eq. 26, which results from multiplying both sides of Eq. 25 by an inverse matrix from the left. The following equation is created using these elements. It is sufficient if observation condition 1 and observation condition 2 are different in, for example, the azimuth angle φ or the elevation angle θ of the geometric structure.

Because the number of elements of the transformation matrix is four, a minimum of two instances of measurement with different observation conditions suffice to determine the transformation matrix, but an effective way to obtain a more robust solution is to perform N (three or more) instances of measurement each with a different observation condition. Assuming that the incident wave and the reflected wave on each observation condition are denoted by X_{iN}=[x_{2N-1}, x_{2N}]^{T} and y_{oN}=[y_{2N-1}, y_{2N}]^{T}, respectively, the elements of the transformation matrix can be represented by Eq. 27 through a pseudo-inverse matrix, which corresponds to a least squares approximation.

$$\begin{matrix}[ Equation 27 ] & \\ [ \begin{matrix}a \\ b \\ c \\ d\end{matrix} ] = {[ \begin{matrix}{x}_{1} & {x}_{1} & 0 & 0 \\ 0 & 0 & {x}_{1} & {x}_{1} \\ ⋮ & ⋮ & ⋮ & ⋮ \\ {x}_{2 N - 1} & {x}_{2 N} & 0 & 0 \\ 0 & 0 & {x}_{2 N - 1} & {x}_{2 N}\end{matrix} ]}^{- 1} [ \begin{matrix}{y}_{1} \\ {y}_{2} \\ {y}_{3} \\ {y}_{4}\end{matrix} ] & ( 27 )\end{matrix}$$

In this case, the elements a to d of the transformation matrix can be determined more robustly. Thus, even in observation conditions involving much noise, the elements of the transformation matrix, i.e., a feature amount indicating the characteristics of a target object or a propagation path, can be determined with increased accuracy by repeating instances of measurement with a plurality of observation conditions.

Further, when such computation is performed with respect to each order of radio vortexes, dependencies of the elements of the transformation matrix, which reflect reflection characteristics or propagation characteristics, on the order of the radio vortexes can be determined. Characteristics dependent on the order of the radio vortexes or the orthogonal basis components of the radio vortexes superimposed can be determined, which makes it possible to acquire more detailed characteristics of a reflector and a scatterer.

### Third Embodiment

FIG. 9 is a block diagram of a radio wave analysis apparatus 102 according to a third embodiment. A change in a geometric structure of a radio wave reflects a feature of a target object (i.e., a reflector or a scatterer). Thus, the radio wave analysis apparatus 102 learns patterns of change in the spherical surface parameters, and accumulates the change patterns in a database, thereby making it possible to estimate information about a target object from limited information, leading to a reduction in measurement time and an improvement in analysis accuracy.

A learner 17 classifies patterns of change in the spherical surface parameters between the geometric structure of the transmission radio signal (i.e., the reference geometric structure) and the geometric structure of the reception radio signal (i.e., the reconstructed geometric structure), outputted from the comparison computation section 16, into a plurality of classes in advance. Conceivable examples of the classes include classes with respect to reflection characteristics, densities, and types of target objects. Relationships between the patterns of change in the spherical surface parameters and the classes learned by the learner 17 are accumulated in a database 18. Referring to the database 18, a classification section 19 classifies a new output from the comparison computation section 16 as one of the classes.

The present invention is not limited to the embodiments described above, but encompasses a variety of modifications. For example, the embodiments and modifications thereof described above have been described in detail for easier understanding of the present invention, and the present invention is not necessarily limited to embodiments that have all the features described above. Also note that at least one feature of any of the embodiments and modifications may be substituted with a feature of another of the embodiments and modifications, and that a feature of any of the embodiments and modifications may be added to the features of another of the embodiments and modifications. Also note that, with respect to at least one of the features of each of the embodiments and modifications, elimination, substitution, and addition of another feature are possible.

### REFERENCE SIGNS LIST

11: radio signal acquisition section
12: orthogonal basis expansion section
13: reference structure acquisition section
14: reconstruction computation section
15: reference radio signal acquisition section
16: comparison computation section
17: learner
18: database
19: classification section
20: spherical surface
30: computer
31: processor
32: memory
33: storage device
34: input I/F
35: output I/F
36: communication I/F
37: input/output port
38: bus
39: input device
40: display device
51: antenna
52: high-frequency circuit
53: intermediate-frequency circuit
61: amplifier
62: local oscillator
63: mixer
64: low-pass filter
65: A/D converter
71: mixer
72: coherent oscillator
73: π/2 phase shifter
74: band-pass filter
75: complex signal acquisition section
100, 101, 102: radio wave analysis apparatus

1. A radio wave analysis apparatus that analyzes a radio wave having a geometric structure, the radio wave analysis apparatus comprising:
a radio signal acquisition section that acquires, as a reception radio signal, a complex signal of a reception electric field of each of elements of an array antenna that receives the radio wave;
an orthogonal basis expansion section that calculates two or more orthogonal basis components from the reception radio signal;
a reference structure acquisition section that acquires reference structure information for identifying components of the radio wave corresponding to a first orthogonal basis and a second orthogonal basis, respectively, the first and second orthogonal bases being orthogonal to each other and being used in modulation of the radio wave through a geometric structure; and
a reconstruction computation section that uses the orthogonal basis components and the reference structure information to compute, as a reconstructed geometric structure, an elevation angle, an azimuth angle, and a radius on a spherical surface having the first orthogonal basis and the second orthogonal basis as poles with respect to the geometric structure of the radio wave, wherein
the orthogonal basis components include an orbital angular momentum component.

2. The radio wave analysis apparatus according to claim 1, further comprising:
a reference radio signal acquisition section that acquires, as a reference geometric structure, an elevation angle, an azimuth angle, and a radius on the spherical surface which together form the geometric structure of the radio wave at a time of transmission, the geometric structure being based on the reference structure information; and
a comparison computation section that compares the reconstructed geometric structure and the reference geometric structure with each other, and outputs a result of the comparison.

3. The radio wave analysis apparatus according to claim 2, wherein
the comparison computation section calculates a transformation matrix for transforming a complex signal of a transmission electric field at the time of transmission of the radio wave to the complex signal of the reception electric field, and
the transformation matrix is a transformation matrix of special unitary group of degree 2.

4. The radio wave analysis apparatus according to claim 1, wherein
the orthogonal basis components further include a polarization component.

5. The radio wave analysis apparatus according to claim 4, wherein
in a case where the orthogonal basis components include polarization components, the components of the radio wave corresponding to the first orthogonal basis and the second orthogonal basis are a combination of a horizontal polarization component and a vertical polarization component, or a combination of a right-handed circular polarization component and a left-handed circular polarization component, and
in a case where the orthogonal basis components include orbital angular momentum components, the components of the radio wave corresponding to the first orthogonal basis and the second orthogonal basis are a combination of clockwise or counterclockwise orbital angular momentum components of arbitrary orders or orbital angular momentum modes.

6. The radio wave analysis apparatus according to claim 1, wherein
the array antenna is a circular array antenna in which the elements are arranged in a circular configuration, and
the orthogonal basis expansion section calculates, as the orbital angular momentum component, a spatial frequency component that is calculated by performing a spatial Fourier transform using a circular harmonic function as an orthogonal basis.

7. The radio wave analysis apparatus according to claim 1, wherein
the geometric structure of the radio wave is represented as a combination of the elevation angle, the azimuth angle, and the radius on the spherical surface having the first orthogonal basis and the second orthogonal basis as the poles and an elevation angle, an azimuth angle, and a radius on a spherical surface having a third orthogonal basis and a fourth orthogonal basis different from the first orthogonal basis and the second orthogonal basis as poles.

8. The radio wave analysis apparatus according to claim 7, wherein
the components of the radio wave corresponding to the first orthogonal basis and the second orthogonal basis are orbital angular momentum components, and components of the radio wave corresponding to the third orthogonal basis and the fourth orthogonal basis are polarization components.

9. The radio wave analysis apparatus according to claim 1, wherein
the reconstructed geometric structure computed by the reconstruction computation section is displayed on a display device as a time locus of a position on the spherical surface.

10. The radio wave analysis apparatus according to claim 2, further comprising:
a learner that learns relationships between patterns of change in the reconstructed geometric structure relative to the reference geometric structure and classes;
a database that accumulates the relationships between the change patterns and the classes learned by the learner; and
a classification section that classifies the result of the comparison outputted from the comparison computation section as one of the classes with reference to the database, wherein
the classes include classes with respect to a target object, and
the radio wave is a radio wave reflected or scattered by the target object.

11. A radio wave analysis method of analyzing a radio wave having a geometric structure, the method comprising:
acquiring, as a reception radio signal, a complex signal of a reception electric field of each of elements of an array antenna that receives the radio wave;
calculating two or more orthogonal basis components from the reception radio signal;
acquiring reference structure information for identifying components of the radio wave corresponding to a first orthogonal basis and a second orthogonal basis, respectively, the first and second orthogonal bases being orthogonal to each other and being used in modulation of the radio wave through a geometric structure; and
using the orthogonal basis components and the reference structure information to compute, as a reconstructed geometric structure, an elevation angle, an azimuth angle, and a radius on a spherical surface having the first orthogonal basis and the second orthogonal basis as poles with respect to the geometric structure of the radio wave, wherein
the orthogonal basis components include an orbital angular momentum component.

12. The radio wave analysis method according to claim 11, further comprising:
acquiring, as a reference geometric structure, an elevation angle, an azimuth angle, and a radius on the spherical surface which together form the geometric structure of the radio wave at a time of transmission, the geometric structure being based on the reference structure information; and
comparing the reconstructed geometric structure and the reference geometric structure with each other, and outputting a result of the comparison.

13. The radio wave analysis method according to claim 12, further comprising:
calculating a transformation matrix for transforming a complex signal of a transmission electric field at the time of transmission of the radio wave to the complex signal of the reception electric field, wherein
the transformation matrix is a transformation matrix of special unitary group of degree 2.

14. The radio wave analysis method according to claim 11, wherein
the orthogonal basis components further include a polarization component.

15. The radio wave analysis method according to claim 12, further comprising:
learning relationships between patterns of change in the reconstructed geometric structure relative to the reference geometric structure and classes in advance, and accumulating the learned relationships between the change patterns and the classes in a database; and
classifying the result of the comparison between the reconstructed geometric structure and the reference geometric structure as one of the classes with reference to the database, wherein
the classes include classes with respect to a target object, and
the radio wave is a radio wave reflected or scattered by the target object.
